(19) United States
(12) Patent Application Publication
(10) Pub. No.: US 2020/0269202 A1
(43) Pub. Date: Aug. 27, 2020

(54) AN APPARATUS FOR AGITATION OF FLUIDS

(71) Applicant: Nakul NAKUL, Gurgaon (IN)

(72) Inventor: Nakul NAKUL, Gurgaon (IN)

(21) Appl. No.: 16/605,354

(22) PCT Filed: Dec. 15, 2018
(86) PCT No.: PCT/IB2018/060146

§ 371 Date: Oct. 15, 2019

(30) Foreign Application Priority Data
Nov. 5, 2018 (IN) 201811041891

(51) Int. Cl. B01F 7/22; B01F 15/00

(52) U.S. Cl. CPC B01F 7/22; B01F 2215/0422; B01F 15/00883

(57) ABSTRACT

An apparatus for agitation of fluids is described that comprises an agitation chamber, an impeller configured to have a motor, a shaft, and blades, and a plurality of baffles. Further, the plurality of baffles have a predetermined shape and configuration. Further, the plurality of baffles are placed on a side wall of the agitation chamber.

### FIELD OF THE INVENTION

Embodiments of the present invention generally relate to fluid mechanics and more particularly to an apparatus for agitation of fluids.

### BACKGROUND OF THE INVENTION

Mixing process is very primitive and popular for human civilization. Mixing as such has changed according to luxury and need for mankind. Mixing is the most important and preliminary mechanical operation carried out in each of different types of processing industries. Uniform and thorough mixing is desired to complete the further mechanical operations, unit as well as chemical operations in less time and satisfactory.

A fully baffled condition (complete vortex elimination, defined as 100% baffle effectiveness) is produced by four flat plates (shape) located at the sidewall of the vessel (placement), of width equal to 1/12 of the vessel's diameter (size). They typically extend the length of the vessel's straight side and are spaced at 90-degree intervals. While four sidewall baffles are generally used in alloy vessel construction, they are not practical in glass-lined reactors. Consequently, glass-lined vessels typically have one baffle which is supported from a top head nozzle. Over the years several different styles of glass-lined baffles have evolved, each one providing improved baffle effectiveness (i.e. vortex reduction) over its predecessors.

The Concave Baffle is another design in glass-lined baffle technology. The premise behind the Concave Baffle is to maximize the drag coefficient of the baffle. For the Concave Baffle, the drag coefficient is 2.3. For the flattened pipe, it is 1.3. This results in increased power investment. The “reaction” which is related to this increase in drag force results in an increase in both energy dissipation (power draw) and top-to-bottom turnover within the vessel.

Therefore, there is a need in the art for an effective agitation of fluids which does not suffer from above mentioned limitations and would maximize the mixing of fluids and can be used in different kinds of reactors.

### SUMMARY OF THE INVENTION

According to an aspect of the invention, an apparatus for agitation of fluids is provided. The apparatus comprises an agitation chamber, an impeller configured to have a motor, a shaft and blades and a plurality of baffles.

The plurality of baffles are having predetermined shape and configuration.

The plurality of baffles are placed on a side wall of said agitation chamber.

In accordance with an embodiment of the present invention, said fluid is selected from the group of newtonian fluid, non-newtonian fluid.

In accordance with an embodiment of the present invention, said agitation chamber is having a predefined shape.

In accordance with an embodiment of the present invention, said motor of said impeller is connected at one end of said shaft and said blades are connected at another end of said shaft.

In accordance with an embodiment of the present invention, said plurality of baffles are sharp edge baffles.

In accordance with an embodiment of the present invention, said sharp edge baffles have, but not limited to, a triangular cross section.

In accordance with an embodiment of the present invention, said plurality of baffles are having varying width.

In accordance with an embodiment of the present invention, said width is increasing from top to bottom of said agitation chamber.

In accordance with an embodiment of the present invention, said varying width baffle is having width gradient in the range, but not limited to, 0.03-0.08.

In accordance with an embodiment of the present invention, said plurality of baffles are made of materials such as, but not limited to, polymer, steel, alloys, glass.

In accordance with an embodiment of the present invention, said plurality of baffles are placed at an interval of predefined between 30° to 180° on said side wall of said agitation chamber.

In accordance with an embodiment of the present invention, said predetermined shape of said plurality of baffles are configured to enhance and aid mixing rate and thus faster cooling & heating of fluid semi fluid substances.

In accordance with an embodiment of the present invention, said plurality of baffles are configured to uniformalise the Temperature Gradient and also aid in achieving rapid control on temperature to attain uniform temperature regime within said agitation chamber.

### BRIEF DESCRIPTION OF DRAWINGS

So that the manner in which the above recited features of the present invention can be understood in detail, a more particular description of the invention, briefly summarized above, may have been referred by examples, some of which are illustrated in the appended drawings. It is to be noted, however, that the appended drawings illustrate only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 1 illustrates an apparatus for agitation of fluids, in accordance with an embodiment of the present invention;

FIG. 2A illustrates side view of the baffle, in accordance with an embodiment of the present invention;

FIG. 2B illustrates cross-sectional view of the baffle, in accordance with an embodiment of the present invention; and

FIG. 3 illustrates an arrangement of plurality of baffles, in accordance with another embodiment of the present invention.

### DETAILED DESCRIPTION OF DRAWINGS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

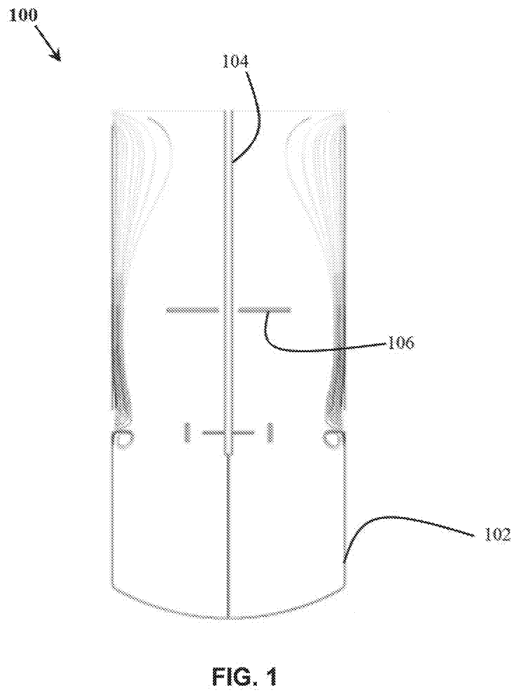

FIG. 1 illustrates an apparatus (100) for agitation of fluids (hereinafter referred as the apparatus (100)), in accordance with an embodiment of the present invention. As shown in FIG. 1, the apparatus (100) for agitation fluids comprises an agitation chamber (102), an impeller configured to have a motor, a shaft (104) and blades (106) and a plurality of baffles (210). The impeller may be, but not limited to a propeller or a turbine. The agitation chamber (102) may have shape, but not limited to, cylindrical, spherical, cuboidal etc. The agitation chamber (102) made of may be, but not limited to, stainless steel, fiber glass have the plurality of baffles (210). The plurality of baffles (210) may be configured to uniformalise the Temperature Gradient and also aid in achieving rapid control on temperature to attain uniform temperature regime within the agitation chamber (102).

The shape of the plurality of baffles (210) are configured to enhance and aid mixing rate and thus faster cooling & heating rate of fluids. The plurality of baffles (210) having a cross section selected from a group comprising, but not limited to, conical, concave, triangular, trapezoidal, preferably triangular, are placed on the walls of inside of the agitation chamber (102). The plurality of baffles (210) are placed at an angle may be, but not limited to, 45°, 90° etc. with the wall of the agitation chamber (102). The angle may be based on the fact that the apparatus (100) may achieve maximum agitation of fluids. The plurality of baffles (210) may be made of materials, but not limited to, polymer, steel, alloys, glass.

The impeller may have the motor, preferable an electrical motor, with the shaft, preferably elongated shaft, is installed inside the agitation chamber (102). The shaft (104) may be fixed with plurality of and blades (106). The motor to the impeller may be connected at one end of the shaft (104) and the blades (106) may be connected at another end of said shaft.

In a preferred embodiment, the apparatus (100) comprises axial symmetric shaft (104) to mount the different types of impellers. The required speed for the operation of impellers is obtained by means of, but not limited to, a 0.5 hp electrical motor attached to the shaft (104) by a belt drive. The constant speeds required were controlled by means of a speed regulator and the speed measurement and the speed is recorded by using a tachometer.

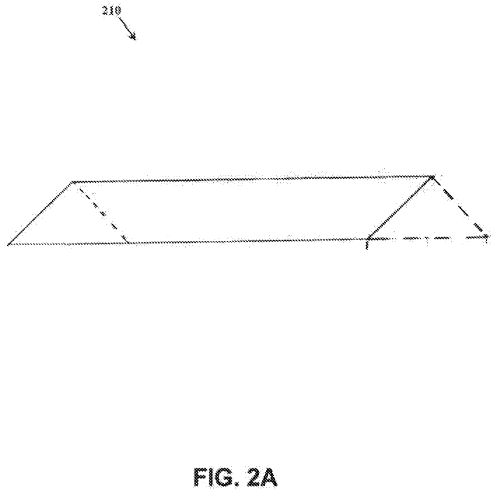

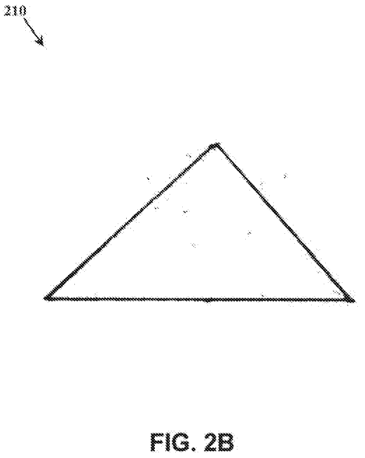

FIG. 2A illustrates side view of the baffle, in accordance with an embodiment of the present invention. In preferred embodiment baffle has, but not limited to, a triangular cross section. The sharp edge of the triangle may be pointed towards the impeller. The plurality of baffles (210) may cut the flux of the liquid under circulation to produce more turbulence and hence improve the mixing. Also, the portion of the fluid that impinges at the sharp edge will be equally divided in two opposite direction which latter impinge on the wall of the tank and rebounded back to the impeller and blades (106). So, this cycle of fluid motion is repeated at a very high rate which results in high turbulence and better mixing.

FIG. 2B illustrates cross-sectional view of each of the plurality of baffle, in accordance with an embodiment of the present invention. As shown in the FIG. 2B, shows the cross-sectional view of the baffle. Each of the plurality of the baffles (210) have shape of the cross section may be, but not limited to, triangular shape, conical shape, concave shape. In the preferred embodiment, the shape of cross section of each of the plurality of the baffles is triangular shape.

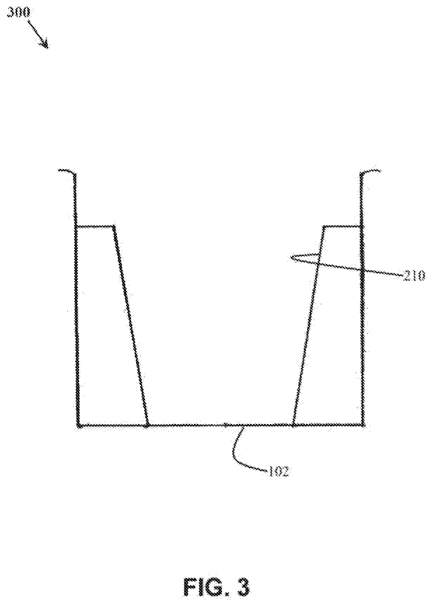

FIG. 3 illustrates an arrangement of plurality of baffles (210), in accordance with another embodiment of the present invention. As shown in the FIG. 3, the plurality of baffles (210) may have a varying width. The varying width may increase from one end to the other end of the agitation chamber (102). A varying width baffle may have a width gradient. In an exemplary embodiment, the width gradient is between the range 0.03-0.08. Preferable the width gradient is 0.05.

The invention works in following manner:

The different fluids are taken in the agitation chamber (102) with the baffles on the wall of agitation chamber (102). The plurality of baffles (210) have a triangular cross section and the sharp edge is pointed towards the impeller. So, it is expected that pointed edge of the baffle would cut the flux of the liquid under circulation to produce more turbulence and hence causes the mixing. Also, the portion of the fluid that impinges at the sharp edge would be equally divided in two opposite direction which latter impinge on the wall of the tank and rebounded back to the impeller and blades (106). So, this cycle of fluid motion is repeated at a very high rate which results in turbulence and mixing.

Where the plurality of baffles (210) having the width increasing from top to bottom of the tank. The area of contact with moving liquid would continuously vary from top to bottom in a stirrer tank. So due to variable contact area this baffle would produce turbulence in case of highly viscous liquids. At near the bottom of tank the gap between baffle and impeller blade would be less. So, in this particular case the energy of fluid at the bottom would be much higher than the fluid at the top of the tank. This would give rise to difference in pressure energy for the fluid at the top and bottom and would result in mixing of fluids.

The present invention offers a number of advantages. The invention produces static uniformity in multi component multiphase system of plurality of fluids in different phases. The invention also produces dynamic uniformity in agitation of multi component multiphase systems. It also facilitates better mass transfer along with the heat transfer between the parts of a systems that are not in equilibrium. The pointed edge of the baffle cuts the flux of the liquid under circulation to produce more turbulence and hence improve the mixing. Also, the portion of the fluid that impinges at the Sharpe edge will be equally divided in two opposite direction which latter impinge on the wall of the tank and rebounded back to the impeller and blades. So, this cycle of fluid motion is repeated at a very high rate which results in high turbulence and better mixing.

In the baffle with width increasing from top to bottom of the tank, the area of contact with moving liquid is continuously varying from top to bottom in a stirrer tank, thus it will enhance heat transfer to the fluid in chamber by virtue of having extra coils with uniformly increasing width of the baffles. So due to variable contact area this baffle will produce turbulence in case of highly viscous liquids. At near the bottom of tank the gap between baffle and impeller blade will be very less. So, in this particular case the energy of fluid at the bottom will be much higher than the fluid at the top of the tank. This will also give rise to difference in pressure energy for the fluid at the top and bottom.

Additionally, the baffles may be used for, but not limited to, biochemical reactors, reactors where there is increase or decrease in degree of volume expansion and for generic drug manufacturing reactors. Furthermore, the varying width baffle has the advantages of transferring and modulation of pressure energy intensity in static structures like pier and bridge foundations where the beam stability requires transverse motions. The varying width aids in stability of heavy structures with vibrations and has advantage over spring system due to long life by maintaining the tensile strength etc.

Various modifications to these embodiments are apparent from the description to those skilled in the art. The principles associated with the various embodiments described herein may be applied to other embodiments. Therefore, the description is not intended to be limited to the embodiments but is to be providing broadest scope consistent with the principles and the novel and inventive features disclosed and/or suggested herein. Accordingly, the invention is anticipated to hold on to all other such alternatives, modifications, and variations that fall within the scope of the present invention and appended claims.

1. An apparatus for agitation of fluids, comprising:
an agitation chamber;
an impeller configured for agitation that comprises a motor, a shaft, and a plurality of blades; and
a plurality of baffles having a triangular cross-section with sharp edges pointing towards the impeller, such that the sharp edges of the plurality of baffles cut a flux of fluid under circulation to produce turbulence, and a portion of the fluid impinging at the sharp edge is divided in two opposite directions which impinge on the wall of the agitation chamber and rebound back to the impeller and the blades;
wherein the plurality of baffles are placed on a side wall of the agitation chamber; and
wherein the plurality of baffles have a width increasing from top to bottom of the agitation chamber, such that an area of contact with moving fluid varies from top to bottom in the agitation chamber.

2. The apparatus of claim 1, wherein the fluid is selected from a group of non-newtonian fluid.

3. The apparatus of claim 1, wherein the agitation chamber has a predefined shape.

4. The apparatus of claim 1, wherein the motor of the impeller is connected at one end of the shaft and the blades are connected at another end of the shaft.

5-8. (canceled)

9. The apparatus of claim 1, wherein the plurality of baffles have a width gradient in the range of 0.03-0.08.

10. The apparatus of claim 1, wherein the plurality of baffles are made of at least one of: polymer, steel, alloys, and glass.

11. The apparatus of claim 1, wherein the plurality of baffles are placed at an interval of predefined angle between 30° to 180° on the side wall of the agitation chamber.

12. The apparatus of claim 1, wherein a predetermined shape of the plurality of baffles is configured to enhance and aid a mixing rate, a cooling rate, and a heating rate of fluids.

13. (canceled)
